(19) United States
(12) Patent Application Publication
(10) Pub. No.: US 2026/0139171 A1
(43) Pub. Date: May 21, 2026

(54) GLASS BONDING COMPOSITION AND GLASS BONDING STRUCTURE

(71) Applicants: Hyundai Motor Company, Seoul (KR); Kia Corporation, Seoul (KR)

(72) Inventor: Jae Cheol Jeon, Hwaseong (KR)

(21) Appl. No.: 19/051,590

(22) Filed: Feb. 12, 2025

(30) Foreign Application Priority Data
Nov. 20, 2024 (KR) 10-2024-0165792

(51) Int. Cl. C09J 175/06; C08G 18/12; C08G 18/42; C08K 3/04; C08K 3/34; C08K 5/10; C08K 5/5415; C08K 7/02

(52) U.S. Cl. CPC C09J 175/06; C08G 18/12; C08G 18/4202; C08K 3/04; C08K 3/346; C08K 5/10; C08K 5/5415; C08K 7/02; C08K 2201/003; C08K 2201/004; C08K 2201/011; C09J 2400/143; C09J 2475/00

(57) ABSTRACT

A glass bonding composition includes a urethane prepolymer, flow regulator, cellulose nanofiber, dispersant, and clay to reduce sag when bonding heavy glass. The composition, containing about 2.2-6 wt % cellulose nanofiber and about 0.2-1.3 wt % dispersant, forms a coating layer that exhibits a thickness increase of about 4 mm or less under a 500 gf tensile load after 1 hour of moisture curing. The cured layer also provides a shear bonding strength of about 3 MPa or more when tested at 50 mm/min with a 250 mm² bonding area. Optional alkoxysilane-based bonding promoters improve adhesion to glass without compromising performance, making this composition suitable for bonding glass to various substrates, including painted members.

### CROSS-REFERENCE TO RELATED APPLICATION

This application claims, under 35 U.S.C. § 119(a), the benefit of Korean Patent Application No. 10-2024-0165792, filed on Nov. 20, 2024, the entire contents of which are incorporated herein by reference.

### BACKGROUND

### Technical Field

The present disclosure relates to a glass bonding composition and a glass bonding structure.

### Background

Currently, a moisture-curable urethane-based glass sealer (often referred as direct glazing urethane, or DGU) is used to bond glass (e.g., windshields, backlites) to a vehicle's painted body. This urethane glass sealer is used for bonding sunroof assemblies to the body. It cures from a liquid to a solid state via a slow reaction with ambient moisture, resulting in a relatively low reaction rate.

Due to this slow curing process, currently available urethane glass sealer may sag when subjected to load after application, and the sagging becomes more pronounced over time, especially in trucks and buses that use heavier glass. To mitigate this, a stopper is applied to the surface of the glass during glass assembly and bonding, and research is needed on improved glass sealers that prevent sagging.

### SUMMARY OF THE DISCLOSURE

The present disclosure has been made keeping in mind the problems encountered in the related art, and an object of the present disclosure is to provide a bonding composition capable of minimizing sagging during bonding and sealing of heavy glass.

Another object of the present disclosure is to provide a bonding composition capable of exhibiting excellent shear bonding strength, chemical resistance, and water resistance when bonding glass.

The objects of the present disclosure are not limited to the foregoing. The objects of the present disclosure will be able to be clearly understood through the following description and to be realized by the means described in the claims and combinations thereof.

In order to accomplish the above objects, the present disclosure provides a glass bonding composition, including a urethane prepolymer, a flow regulator, cellulose nanofiber, a dispersant, and clay, in which the glass bonding composition may include, based on a total of 100 wt % of the composition, 10 wt % to 20 wt % of the flow regulator, 2.2 wt % to 6 wt % of the cellulose nanofiber, and 0.2 wt % to 1.3 wt % of the dispersant.

As discussed, the method and system suitably include use of a controller or processer.

In another embodiment, vehicles are provided that comprise an apparatus as disclosed herein.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 schematically shows an example of application of a glass sealer (glass bonding composition);

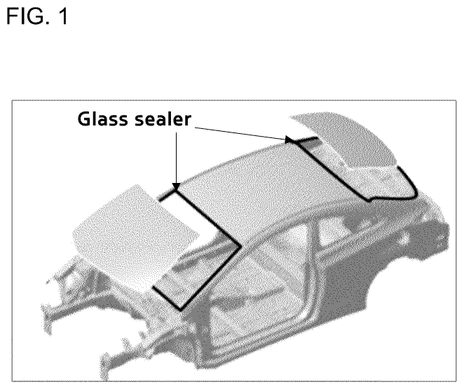

FIG. 2 schematically shows a process of evaluating sagging in Test Example;

FIG. 3 is photographs showing results of measurement of sagging (thickness change) of Example and Comparative Examples (C. Examples); and

FIG. 4 schematically shows a process of evaluating shear bonding strength in Test Example.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “urethane prepolymer” as used herein refers to a low-molecular-weight compound formed by reacting a polyol component having two or more hydroxyl groups per molecule with an isocyanate-based compound, and which typically contains residual isocyanate groups.

The term “flow regulator” as used herein refers to one or more materials (e.g., carbon black, graphite, calcium carbonate, etc.) that help control the dischargeability and viscosity of the composition during application, as well as impart weather resistance.

The term “cellulose nanofiber” as used herein refers to fibers derived from cellulose, having a typical diameter of about 10 nm to 100 nm and a length of about 1 μm to 5 μm, employed to modulate viscosity, minimize sagging, and maintain elongation properties of the composition.

The term “dispersant” as used herein refers to a polymeric material substantially free of silicone components that facilitates uniform dispersion of cellulose nanofiber or other solids (such as the flow regulator) within the urethane prepolymer or plasticizer matrix. Examples include polypropylene, polyester, polycarboxylic acid, polyvinyl alcohol, polyethylene glycol, polyvinylpyrrolidone, carboxymethyl cellulose, and the like.

The term “clay” as used herein refers to a layered silicate mineral, such as kaolinite, illite, montmorillonite, smectite, or chlorite, which may be used in calcined form. Clay serves to reinforce the composition's volume and enhance workability while maintaining suitable bonding performance.

The term “plasticizer” as used herein refers to a component, such as a phthalate-based compound (e.g., diisononyl phthalate, diethylhexyl phthalate), added to impart flexibility and elongation to the cured coating, and which can also contribute to heat resistance.

The term “bonding promoter” as used herein refers to an alkoxysilane-based compound (e.g., trimethoxysilane, triethoxysilane, etc.) that improves adhesion to various substrates (especially glass) without significantly detracting from the composition's mechanical or chemical resistance properties.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

The present disclosure is devised to solve the problems described above by adding predetermined amounts (wt %) of cellulose nanofiber, a flow regulator, and a dispersant to a urethane-based glass sealer, reducing sagging of the glass sealer, which will be described in detail below.

### Glass Bonding Composition

A glass bonding composition according to an aspect of the present disclosure may include a urethane prepolymer, a flow regulator, cellulose nanofiber, a dispersant, and clay, and may include, based on a total of 100 wt % of the composition, 10 wt % to 20 wt % of the flow regulator, 2.2 wt % to 6 wt % of the cellulose nanofiber, and 0.2 wt % to 1.3 wt % of the dispersant.

The urethane prepolymer may be a low-molecular-weight compound in which a polyol component and an isocyanate component are bound, and may contain residual isocyanate groups.

The urethane prepolymer may be in a liquid state and may be in a form having predetermined viscosity.

The polyol component may include a polyol having two or more hydroxyl groups per molecule, and examples thereof may include polyhydric alcohol compounds, polyether polyols, polyester polyols, polycarbonate polyols, etc. Here, the polyhydric alcohol compound may include ethylene glycol, diethylene glycol, propylene glycol, dipropylene glycol, butanediol, pentanediol, neopentyl glycol, hexanediol, cyclohexanedimethanol, glycerin, trimethylolpropane, pentaerythritol, and the like.

The weight average molecular weight of the polyol component may be 100 g/mol to 8,000 g/mol.

The isocyanate component may be an isocyanate-based compound having two or more isocyanate groups (—NCO) per molecule, and examples thereof may include hexamethylene diisocyanate (HDI), trimethylhexamethylene diisocyanate (TMHDI), toluene diisocyanate (TDI), methylene diphenyl diisocyanate (MDI), isophorone diisocyanate (IPDI), cyclohexyl methane diisocyanate (DHDI), and the like.

The urethane prepolymer may contain 0.5 wt % to 10 wt % of isocyanate groups.

The urethane prepolymer may include a first urethane prepolymer and a second urethane prepolymer.

The first urethane prepolymer may be obtained by reacting the polyol component and the methylene diphenyl diisocyanate (MDI) component.

The second urethane prepolymer is obtained by reacting the polyol component and the polyfunctional isocyanate component, and may contain a silane functional group. The silane functional group may include, for example, an alkoxysilane, and may be formed at the end of the second urethane prepolymer.

Based on a total of 100 wt % of the composition, the amount of the urethane prepolymer may be 36 wt % to 55 wt %, or 40 wt % to 49 wt %. Specifically, the urethane prepolymer may include 28 wt % to 40 wt % of the first urethane prepolymer and 8 wt % to 15 wt % of the second urethane prepolymer, or 30 wt % to 35 wt % of the first urethane prepolymer and 10 wt % to 14 wt % of the second urethane prepolymer.

If the amount of the first urethane prepolymer is less than 28 wt %, shear bonding strength may decrease during bonding. On the other hand, if the amount of the first urethane prepolymer exceeds 40 wt %, adhesion to the bonding target may decrease.

If the amount of the second urethane prepolymer is less than 8 wt %, shear bonding strength may decrease during bonding, and adhesion to glass may become poor. On the other hand, if the amount of the second urethane prepolymer exceeds 15 wt %, storage stability, water resistance, and chemical resistance may deteriorate. Here, chemical resistance may be resistance to washer fluid.

The flow regulator may serve to control dischargeability and bonding strength when discharging the composition through a discharge means, and also to impart weather resistance.

The flow regulator may include, for example, any one selected from the group consisting of carbon black, graphite, calcium carbonate, silica, alumina, titania, zirconia, and combinations thereof, and preferably includes carbon black.

The amount of the flow regulator may be 10 wt % to 20 wt %, or 12 wt % to 18 wt %. If the amount of the flow regulator is less than 10 wt %, unnecessary flow may occur during discharge due to decreased viscosity, and shear bonding strength may decrease during bonding. On the other hand, if the amount of the flow regulator exceeds 20 wt %, dischargeability may be reduced and adhesion to glass may decrease.

The cellulose nanofiber may serve to control initial viscosity and elongation of the composition.

The amount of the cellulose nanofiber may be 2.2 wt % to 6 wt %, or 3 wt % to 5 wt %. If the amount of the cellulose nanofiber is less than 2.2 wt %, the effect of inhibiting sagging of the composition may be insufficient. On the other hand, if the amount of the cellulose nanofiber exceeds 6 wt %, adhesion to glass may decrease.

The cellulose nanofiber may have a diameter of 10 nm to 100 nm and a length of 1 μm to 5 μm. If the length of the cellulose nanofiber is less than 1 μm, the effect of viscosity control may be insufficient. On the other hand, if the length of the cellulose nanofiber exceeds 5 μm, adhesion to the bonding target may decrease due to entanglement.

The dispersant may serve to evenly disperse cellulose nanofiber. The dispersant may be dispersed in a liquid urethane prepolymer or plasticizer.

The amount of the dispersant may be 0.2 wt % to 1.3 wt %, or 0.5 wt % to 1 wt %. If the amount of the dispersant is less than 0.2 wt %, aggregation may occur due to decreased dispersibility of the cellulose nanofiber, and adhesion to the bonding target may decrease. On the other hand, if the amount of the dispersant exceeds 1.3 wt %, adhesion to the bonding target may decrease.

The dispersant may include a polymer substantially free of a silicone component, and may include a polymer containing an ether group, an ester group, a hydroxyl group, an alkyl group, etc. in a repeat unit. For example, the dispersant may include any one selected from the group consisting of polypropylene, polyester, polycarboxylic acid, polyvinyl alcohol, polyethylene glycol, polyvinyl pyrrolidone, carboxymethyl cellulose, and combinations thereof.

The plasticizer may serve to impart flexibility and elongation to the composition, and additionally heat resistance.

The plasticizer may be included in an amount of 18 wt % to 30 wt %, or 20 wt % to 25 wt %, based on a total of 100 wt % of the composition. If the amount of the plasticizer is less than 18 wt %, it may be difficult to obtain appropriate elongation. On the other hand, if the amount of the plasticizer exceeds 30 wt %, heat resistance may deteriorate.

The plasticizer may include a phthalate-based compound, and may include any one selected from the group consisting of diisononyl phthalate, diethylhexyl phthalate, diethyl phthalate, butyl benzyl phthalate, dimethyl terephthalate, dibutyl phthalate, and combinations thereof.

The clay may serve to reinforce the volume of the composition and impart workability.

The clay may be included in an amount of 8 wt % to 20 wt %, or 10 wt % to 16 wt %, based on a total of 100 wt % of the composition. If the amount of the clay is less than 8 wt %, the volume reinforcing effect may be insufficient. On the other hand, if the amount of the clay exceeds 20 wt %, shear bonding strength may decrease during bonding.

The clay may correspond to a layered silicate mineral having high moisture absorption and may include any one selected from the group consisting of kaolinite, illite, montmorillonite, smectite, chlorite, and combinations thereof. Also, the clay may be used in a calcined form with volatile components (water, carbon dioxide), etc. removed.

The glass bonding composition may also include a bonding promoter including an alkoxysilane-based compound. Based on a total of 100 wt % of the composition, the amount of the bonding promoter may be 0.8 wt % to 5 wt %, or 1 wt % to 4 wt %. If the amount of the bonding promoter is less than 0.8 wt %, an improvement in adhesion to the bonding target may be minimal. On the other hand, if the amount of the bonding promoter exceeds 5 wt %, storage stability, water resistance, and chemical resistance may deteriorate. Here, chemical resistance may be resistance to washer fluid.

The alkoxysilane-based compound included in the bonding promoter may include any one selected from the group consisting of trimethoxysilane, triethoxysilane, tetramethoxysilane, tetraethoxysilane, vinyltrimethoxysilane, dimethyldimethoxysilane, dimethyldiethoxysilane, and combinations thereof, and an example thereof may include trimethoxysilane.

In addition, the glass bonding composition may satisfy the following sagging and shear bonding strength related parameters.

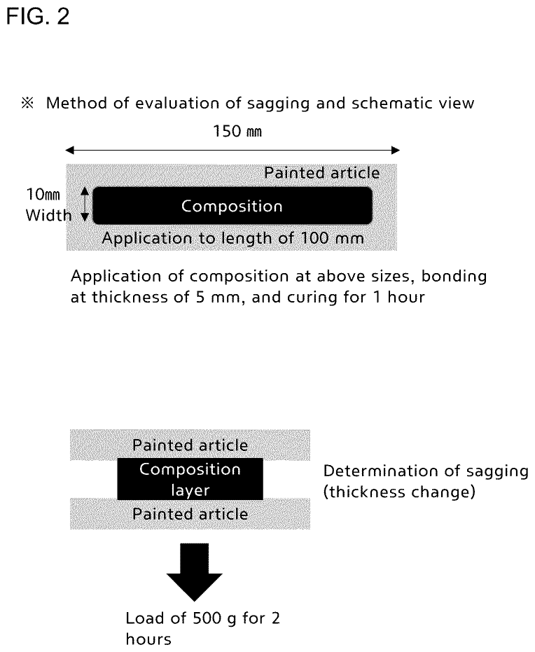

As shown in FIG. 2, when a coating layer of the glass bonding composition having a length of 100 mm, a width of 10 mm, and a thickness of 5 mm is formed and stacked on a partial region between a first plate and a second plate followed by moisture curing for 1 hour and then application of a tensile force of 500 gf (0.5 gf/mm² based on the bonding area) for 2 hours in the direction of stacking of the first plate and the second plate, an increase in thickness based on the original thickness of the coating layer may be 4 mm or less and may be 0.1 mm or more. With this increase in thickness, namely a sagging value, it is possible to prevent sagging and obtain good bonding quality even when bonding and assembling heavy glass used in large vehicles, buses, trucks, etc.

The first and second plates may be painted articles. The coating composition applied onto a painted article or the coating composition applied onto a painted member may include a typical polymer binder (epoxy resin, acrylic resin, polyester resin, etc.), pigment, dispersant, solvent, etc.

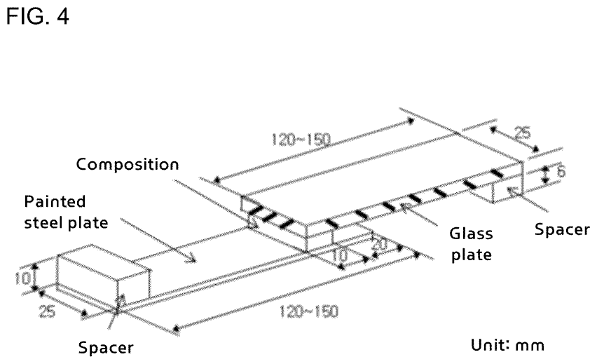

As shown in FIG. 4 (unit: mm), shear bonding strength measured at a load application speed of 50 mm/min for a test specimen including a coating layer of the glass bonding composition with a thickness of 5 mm and a bonding area of 250 mm² applied onto a partial region between a glass member (glass plate) and a painted member (painted steel plate) may be 3 MPa or more, 4 MPa or more, and 8 MPa or less. With this shear bonding strength, it is possible to prevent sagging and obtain good bonding quality even when bonding and assembling heavy glass used in large vehicles, buses, trucks, etc.

The glass member surface may include typical glass, and may include so-called soda-lime glass, borosilicate glass, aluminosilicate glass, etc. In addition, the surfaces of the first glass member and the second glass member may include a typical primer or coating layer, and may include a silane coupling agent, polysiloxane, silica, or the like.

The glass bonding composition may be prepared by mixing the listed components and may be packaged while minimizing moisture inflow. Since the urethane prepolymer, plasticizer, etc. are in a liquid state, a separate solvent may not be added.

### Glass Bonding Structure

A glass bonding structure according to another aspect of the present disclosure may include a first bonding target, a second bonding target, and a coating layer of the glass bonding composition applied onto at least a partial region therebetween.

The coating layer is cured, and at least one of the first bonding target or the second bonding target may include glass.

When the remaining bonding target other than the bonding target including glass is not glass, the remaining bonding target may include a painted member, a plastic member, etc., the components of which may be as described above.

The bonding target including glass may include a separate primer or coating layer on the surface thereof, the components of which may be as described above.

A better understanding of the present disclosure may be obtained through the following example and comparative examples. However, these examples are not to be construed as limiting the technical spirit of the present disclosure.

### Example 1

A one-component liquid composition was prepared by mixing 31.3 wt % of a first urethane prepolymer obtained by reacting polyester polyol and methylene diphenyl diisocyanate (MDI), 11.6 wt % of an alkoxysilane-modified second urethane prepolymer, 15 wt % of a carbon black flow regulator, 4.1 wt % of cellulose nanofiber, 0.7 wt % of a polyester dispersant, 22.6 wt % of a diisononyl phthalate plasticizer, 12.8 wt % of calcined clay (kaolin-based), and 1.9 wt % of a trimethoxysilane bonding promoter, based on a total of 100 wt % of the composition.

### Comparative Examples 1 to 6

Respective liquid compositions were prepared by changing the amounts (wt %) of the components in Example 1 as shown in Table 1 below.

TABLE 1

| | | Comparative | Comparative | Comparative | Comparative | Comparative | Comparative |
|---|---|---|---|---|---|---|---|
| Component | Example 1 | Example 1 | Example 2 | Example 3 | Example 4 | Example 5 | Example 6 |
| First | 31.3 | 32.2 | 31.6 | 30.3 | 31.5 | 31.1 | 33.6 |
| urethane | | | | | | | |
| prepolymer | | | | | | | |
| Second | 11.6 | 13.1 | 12.1 | 11.5 | 11.7 | 11 | 12.6 |
| urethane | | | | | | | |
| prepolymer | | | | | | | |
| Flow | 15 | 16 | 15.2 | 14.7 | 15.1 | 15 | 8 |
| regulator | | | | | | | |
| Cellulose | 4.1 | — | 2 | 6.2 | 4.1 | 4.1 | 4.1 |
| nanofiber | | | | | | | |
| Dispersant | 0.7 | — | 0.7 | 0.7 | 0.1 | 1.5 | 0.7 |
| Plasticizer | 22.6 | 23.1 | 23 | 22.3 | 22.7 | 22.6 | 23.5 |
| Clay | 12.8 | 13.7 | 13.5 | 12.4 | 12.9 | 12.8 | 15.6 |
| Bonding | 1.9 | 1.9 | 1.9 | 1.9 | 1.9 | 1.9 | 1.9 |
| promoter | | | | | | | |
| Total | 100 | 100 | 100 | 100 | 100 | 100 | 100 |

Unit: wt %

### Test Example—Measurement of Dischargeability, Sagging, Shear Strength, and Adhesion to Painted Member and Glass Member

### 1) Dischargeability

The composition of each of Example and Comparative Examples was placed in a dispenser and discharged at a pressure of 5 bar, and dischargeability was visually evaluated. The results thereof are shown in Table 2 below.

### 2) Sagging

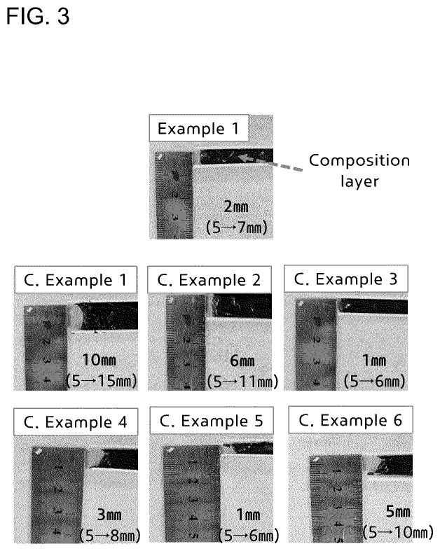

After forming and stacking a coating layer of the composition of each of Example and Comparative Examples having a length of 100 mm, a width of 10 mm, and a thickness of 5 mm on a partial region between a painted first plate and a painted second plate, moisture curing was performed for 1 hour, followed by application of a tensile force of 500 gf for 2 hours in the direction of stacking of the first and second plates, and a change in the thickness of the coating layer was measured. The results thereof are shown in Table 2 below and FIGS. 2 and 3.

### 3) Shear Bonding Strength

As shown in FIG. 4, a test specimen including a coating layer of the glass bonding composition of each of Example and Comparative Examples with a bonding area of 250 mm² applied onto a partial region between a glass member and a painted member was prepared, and shear bonding strength was measured at a load application speed of 50 mm/min for the test specimen. The results thereof are shown in Table 2 below.

### 4) Adhesion to Painted Member and Glass Member

A coating layer of the glass bonding composition of each of Example and Comparative Examples was formed on the painted member and the glass member and then cured for 7 days at 20° C. and a relative humidity of 65%, after which one end of the coating layer was cut with a knife, and then the member was held and the coating layer was peeled off at an angle of 30 degrees from the member. As such, the area of the composition attached to each member is represented as %, and the results thereof are shown in Table 2 below. Here, 100% indicates aggregation destruction of the coating layer, and if it is less than 100%, it indicates that there is an interfacial peeling portion between the coating layer and the member.

TABLE 2

| Evaluation | | Comparative | Comparative | Comparative | Comparative | Comparative | Comparative |
|---|---|---|---|---|---|---|---|
| items | Example 1 | Example 1 | Example 2 | Example 3 | Example 4 | Example 5 | Example 6 |
| Dischargeability | Good | Good | Good | Good | Partial | Good | Excessive |
| | discharge | discharge | discharge | discharge | aggregation | discharge | flow |
| Sagging | 2 | 10 | 6 | 1 | 3 | 1 | 5 |
| (mm) | | | | | | | |
| Shear | 4.7 | 3.3 | 3.7 | 2.5 | 3.4 | 3.2 | 2.8 |
| strength | | | | | | | |
| (MPa) | | | | | | | |
| Adhesion to | 100% | 100% | 100% | 50% | 100% | 60% | 80% |
| painted | | | | | | | |
| member | | | | | | | |
| Adhesion to | 100% | 100% | 100% | 70% | 100% | 80% | 80% |
| glass member | | | | | | | |

Referring to FIG. 2, 3 and Table 2, in Example 1, in which the cellulose nanofiber and the dispersant were used in appropriate amounts, dischargeability and sagging resistance were excellent, and also shear bonding strength and adhesion to the painted member and the glass member were good.

In Comparative Example 1, in which the cellulose nanofiber and the dispersant were not used, sagging was not suppressed and an increase in the thickness of the coating layer was high.

In Comparative Example 2, in which the cellulose nanofiber was used in less than an appropriate amount, sagging was somewhat poor.

In Comparative Example 3, in which the cellulose nanofiber was used in greater than an appropriate amount, sagging was good, but adhesion to the painted member and the glass member was poor.

In Comparative Example 4, in which the dispersant was used in less than an appropriate amount, aggregation occurred during discharge, resulting in poor workability and usability.

In Comparative Example 5, in which the dispersant was used in greater than an appropriate amount, adhesion to the painted member and the glass member was poor.

In Comparative Example 6, in which the flow regulator was used in less than an appropriate amount, excessive flow occurred during discharge, and sagging, shear bonding strength, and adhesion between the members were poor.

As is apparent from the foregoing, according to the present disclosure, a glass bonding composition can minimize sagging during bonding and sealing of heavy glass, and exhibit excellent shear bonding strength, chemical resistance, and water resistance during bonding.

The effects of the present disclosure are not limited to the foregoing. It should be understood that the effects of the present disclosure include all effects that can be inferred from the description of the present disclosure.

Although specific embodiments of the present disclosure have been described with reference to the attached drawings, those skilled in the art will appreciate that the present disclosure may be embodied in other specific forms without changing the technical spirit or essential features thereof. Thus, the embodiments described should be understood to be non-limiting and illustrative in every way.

What is claimed is:

1. A glass bonding composition comprising:
a urethane prepolymer; a flow regulator; cellulose nanofiber; a dispersant; and clay,
wherein the glass bonding composition comprises, based on a total of 100 wt % of the composition, about 2.2 wt % to 6 wt % of the cellulose nanofiber, and about 0.2 wt % to 1.3 wt % of the dispersant.

2. The glass bonding composition of claim 1, wherein the urethane prepolymer comprises a first urethane prepolymer and a second urethane prepolymer, and the second urethane prepolymer comprises a silane-modified urethane prepolymer.

3. The glass bonding composition of claim 2, wherein the first urethane prepolymer comprises a portion derived from a methylene diphenyl diisocyanate (MDI) monomer.

4. The glass bonding composition of claim 2, comprising about 28 wt % to 40 wt % of the first urethane prepolymer and about 8 wt % to 15 wt % of the second urethane prepolymer, based on a total of 100 wt % of the composition.

5. The glass bonding composition of claim 1, wherein the glass bonding composition comprises, based on a total of 100 wt % of the composition, about 10 wt % to 20 wt % of the flow regulator comprising any one selected from the group consisting of carbon black, graphite, calcium carbonate, silica, alumina, titania, zirconia, and a combination thereof.

6. The glass bonding composition of claim 1, wherein the cellulose nanofiber has a diameter of about 10 nm to 100 nm and a length of about 1 μm to 5 μm.

7. The glass bonding composition of claim 1, wherein the dispersant comprises any one selected from the group consisting of polypropylene, polyester, polycarboxylic acid, polyvinyl alcohol, polyethylene glycol, polyvinylpyrrolidone, carboxymethyl cellulose, and a combination thereof.

8. The glass bonding composition of claim 1, comprising about 18 wt % to 30 wt % of a plasticizer and about 8 wt % to 20 wt % of the clay, based on a total of 100 wt % of the composition.

9. The glass bonding composition of claim 1, further comprising about 0.8 wt % to 5 wt % of a bonding promoter comprising an alkoxysilane-based compound, based on a total of 100 wt % of the composition.

10. The glass bonding composition of claim 1, wherein the plasticizer comprises any one selected from the group consisting of diisononyl phthalate, diethylhexyl phthalate, diethyl phthalate, butyl benzyl phthalate, dimethyl terephthalate, dibutyl phthalate, and a combination thereof.

11. The glass bonding composition of claim 1, wherein the clay comprises any one selected from the group consisting of kaolinite, illite, montmorillonite, smectite, chlorite, and a combination thereof.

12. The glass bonding composition of claim 1, wherein, when a coating layer of the glass bonding composition having a length of about 100 mm, a width of about 10 mm, and a thickness of about 5 mm is formed and stacked on a partial region between a first plate and a second plate followed by moisture curing for about 1 hour and then application of a tensile force of about 500 gf for about 2 hours in a direction of stacking of the first plate and the second plate, an increase in thickness of the coating layer based on an original thickness of the coating layer is about 4 mm or less.

13. The glass bonding composition of claim 1, wherein shear bonding strength measured at a load application speed of about 50 mm/min for a test specimen comprising a coating layer of the glass bonding composition with a bonding area of about 250 mm² applied onto a partial region between a glass member and a painted member is about 3 MPa or more.

14. A glass bonding structure, comprising a first bonding target; a second bonding target; and a coating layer of the glass bonding composition of claim 1 applied onto at least a partial region between the first bonding target and the second bonding target, wherein the coating layer is cured, and at least one of the first bonding target or the second bonding target comprises glass.

15. A glass bonding composition for minimizing sagging when bonding heavy glass, the composition comprising:
a urethane prepolymer, a flow regulator, cellulose nanofiber, a dispersant, and clay,
wherein, when a coating layer of the composition having a length of about 100 mm, a width of about 10 mm, and a thickness of about 5 mm is formed on a partial region between two plates, moisture-cured for about 1 hour, and then subjected to a tensile force of about 500 gf in a stacking direction of the plates for about 2 hours, an increase in thickness of the coating layer based on an original thickness thereof is about 4 mm or less.

16. The glass bonding composition of claim 15, wherein the cellulose nanofiber is present in an amount of about 2.2 wt % to 6 wt % based on 100 wt % of the composition and has a diameter of about 10 nm to 100 nm and a length of about 1 μm to 5 μm.

17. The glass bonding composition of claim 16, wherein the dispersant is present in an amount of about 0.2 wt % to 1.3 wt % based on 100 wt % of the composition and comprises any one selected from the group consisting of polypropylene, polyester, polycarboxylic acid, polyvinyl alcohol, polyethylene glycol, polyvinylpyrrolidone, carboxymethyl cellulose, and a combination thereof.
